(19) United States
(12) Patent Application Publication
(10) Pub. No.: US 2026/0202437 A1
(43) Pub. Date: Jul. 16, 2026

(54) METHOD OF ESTIMATING THE CORNER ACCELERATIONS OF A VEHICLE BASED ON SIGNALS PROVIDED BY AN IMU

(71) Applicant: e-Shock S.r.l., Milano (MI) (IT)

(72) Inventors: Diego Delvecchio, Milano (MI) (IT); Agnese Palmieri, Roma (RM) (IT); Alessandro Simonelli, Dello (BS) (IT); Andrea Angelo Pietro Zorzutti, Milano (MI) (IT)

(21) Appl. No.: 19/133,182

(22) PCT Filed: Nov. 23, 2023
(86) PCT No.: PCT/IB2023/061836

§ 371 Date: May 27, 2025

(30) Foreign Application Priority Data
Nov. 25, 2022 (IT) 102022000024327

(51) Int. Cl. G01P 15/18; B60G 17/019; G01P 15/08

(52) U.S. Cl. CPC G01P 15/18; G01P 15/08; B60G 17/01908; B60G 2400/102; B60G 2400/20; B60G 2401/00

(57) ABSTRACT

This invention relates to a method for estimating, by means of rigid body kinematic equations, the relative acceleration along the vertical axis of the corners of a vehicle on the basis of measurements of linear acceleration along the vertical axis and angular velocities provided by a single IMU whose position with respect to the corners of the vehicle is known. The linear acceleration and angular velocities are suitably filtered in order to obtain an estimate of the acceleration of the corners that is more faithful to the real acceleration, i.e. the acceleration measured by sensors positioned on the corners.

### TECHNICAL FIELD

This description relates to the field of vehicle suspensions and more specifically to the correct setting and control of active or semi-active suspensions.

### BACKGROUND

The use of active or semi-active suspension is well known in the automotive sector. By knowing the acceleration values along a vertical Z-axis of the chassis corners, i.e. the portions of the chassis at the wheels of the vehicle, it is possible to control the behaviour of the active or semi-active suspension in order to achieve better vehicle performance and/or greater driving comfort. Accelerometers placed at the suspension or directly integrated within the suspension are generally used for this purpose.

However, the use of a high number of sensors is expensive and greatly increases the complexity of the instrumentation installed on the vehicle, causing drawbacks.

### SUMMARY OF THE INVENTION

A purpose of the present invention is to provide a method for estimating the vertical accelerations of the angles of a vehicle that solves the drawbacks of the prior art.

This and other purposes are fully achieved according to the present invention by the method according to claim 1.

Preferred embodiments of the method according to the present invention are the subject matter of dependent claims 2-9, the contents of which are to be understood as part of the description below.

A further purpose of the present invention is to provide a vehicle configured to operate advantageously according to the above method, as defined by independent claim 10.

The invention is based on the idea of estimating, by means of rigid body kinematic equations, the relative acceleration along the vertical axis of the vehicle corners on the basis of linear acceleration measurements along the vertical axis and angular velocities provided by a single IMU whose position with respect to the vehicle corners is known. The linear acceleration and angular velocities are suitably filtered in order to obtain an estimate of the acceleration of the corners that is more faithful to the real acceleration, i.e. the acceleration measured by sensors positioned on the corners.

The use of a band-pass filter to filter the measurement of the vertical acceleration of the IMU makes it advantageous to remove the offset introduced by the gravitational component and filter the signal to the desired band. In particular, the intervals 0.1 Hz-2 Hz for the first cutoff frequency and 40 Hz-100 Hz for the second cutoff frequency are particularly effective intervals for obtaining a signal that is less noisy but fast enough to be used for suspension control.

By using a double pole in the range of 10 Hz-100 Hz for the derivative filter used to obtain the measurement of angular accelerations from angular velocities, it is advantageously possible to derive the angular velocities provided by the inertial platform. This implementation makes the derivative filter feasible, solving the high-frequency gain difficulty of the ideal derivative filter.

Thanks to the elimination of the coordinate dependency zᵢ of the estimated vertical corner accelerations, the implementation of the method is advantageously simplified from a computational point of view with minimal losses in terms of error between estimated and actual acceleration.

### BRIEF DESCRIPTION OF THE DRAWINGS

Further advantages and features of the method for estimating the corner accelerations of a vehicle according to the present invention will be apparent to those skilled in the art from the following detailed and non-limiting description of its embodiment with reference to the accompanying drawing, in which:

FIG. 1 shows a schematic representation of a vehicle on which a system of Cartesian axes (vertical axis Z, longitudinal axis X, transversal axis Y) is defined at an IMU and on which the accelerations according to axes parallel to the vertical axis Z of the four corners of the vehicle are identified.

### DETAILED DESCRIPTION

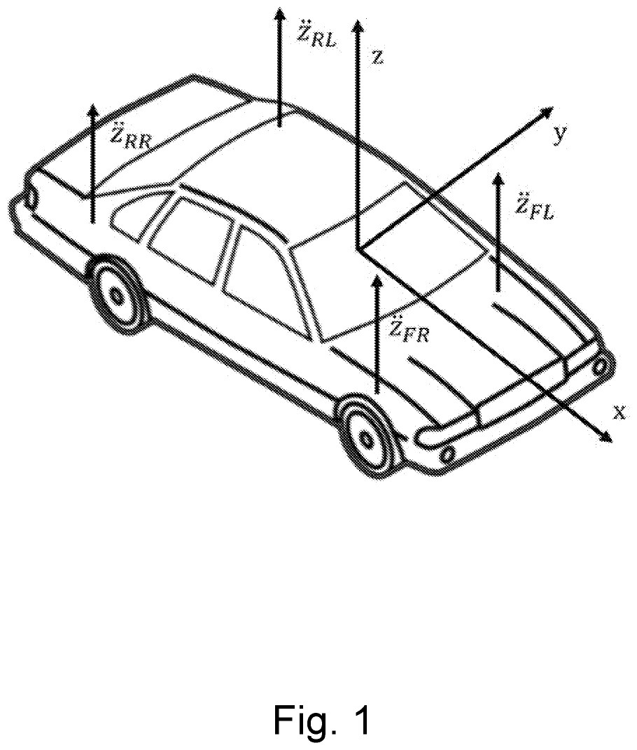

Referring to FIG. 1, one can observe a four-wheel vehicle in which a system of Cartesian axes is defined, a vertical axis Z, a longitudinal axis X, perpendicular to Z and directed in the rear-front direction of the vehicle, and a transverse axis Y perpendicular to both the vertical axis Z and the longitudinal axis X. The method according to the invention is suitable for obtaining at least one signal indicative of an acceleration \ddot{z}ᵢ of at least one corner of said vehicle, for example, in the case of a vehicle such as that of FIG. 1, four signals \ddot{z}_{FR}, \ddot{z}FL, \ddot{z}_{RR}, \ddot{z}_{RL} each indicative of an acceleration of a respective corner of said vehicle along axes parallel to the vertical axis Z. It is to be understood that the corner of a vehicle means the portions or areas of the chassis at which the wheels are mounted.

The vehicle comprises, at the intersection of the Cartesian axes X, Y, Z an IMU configured to provide at least four signals, a first signal a_{z} representative of an acceleration of said IMU along the vertical axis Z, a second signal ωₓ representative of an angular velocity of said IMU about the longitudinal axis X, a third signal ω_{y} representative of an angular velocity of said IMU about the transverse axis Y, and a fourth signal ω_{z} representative of an angular velocity of said IU about the vertical axis Z. It is to be understood that the Cartesian axes of reference X, Y, Z are chosen according to the position of the IU, in other words, the IU is in position [0, 0, 0] with respect to the system of axes of reference X, Y, Z. Consequently, the corners i have a relative position [xᵢ, yᵢ, zᵢ]^{T} with respect to the IMU in position [0, 0, 0]. It is always to be understood that the IMU is connected essentially rigidly to the corners, for example by means of the car body.

The method according to the invention for finding the acceleration \ddot{z}ᵢ along the vertical axis Z of a generic corner i comprises the following steps:
a. filtering said first signal a_{z} with a band-pass filter to obtain a first filtered signal

$${a}_{z}^{bp} ;$$

b. filtering said second signal ωₓ with a derivative filter to obtain the angular acceleration \dot{ω}ₓ around the longitudinal axis X;
c. filtering said third signal ω_{y} with a derivative filter, preferably the same as the derivative filter already used to obtain \dot{ω}ₓ, to obtain the angular acceleration \dot{ω}_{y} around the transverse axis Y;
d. calculating, for each corner i, a fifth signal \ddot{z}ᵢ^{diff} representative of the relative motion of corner i with respect to the IMU, where said fifth signal \ddot{z}ᵢ^{diff} is calculated, by means of the kinematic equations of the rigid body, as

$${\ddot{z}}_{i}^{diff} = [ \begin{matrix}- {\dot{ω}}_{y} + {ω}_{x} {ω}_{z} & {\dot{ω}}_{x} + {ω}_{y} {ω}_{z} & - {ω}_{y}^{2} - {ω}_{x}^{2}\end{matrix} ] \times {[ {x}_{i} , {y}_{i} , {z}_{i} ]}^{T} = - {x}_{i} {\dot{ω}}_{y} + {y}_{i} {\dot{ω}}_{x} - {z}_{i} {ω}_{y}^{2} + {y}_{i} {ω}_{y} {ω}_{z} - {z}_{i} {ω}_{x}^{2} + {x}_{i} {ω}_{x} {ω}_{z} ;$$

e. calculating, for each corner i, said acceleration \ddot{z}ᵢ of said at least one corner i as the sum of said first filtered signal

$${a}_{z}^{bp}$$

and said fifth signal \ddot{z}ᵢ^{diff} i.e. as \ddot{z}ᵢ=a_{z}+\ddot{z}ᵢ^{diff}.
   Preferably, the bandpass filter has a first cut-off frequency in the range of 0.1 Hz-2 Hz and a second cut-off frequency in the range of 40 Hz-100 Hz. The transfer function F(s)_{bp} of the filter is

$${F ( s )}_{bp} = \frac{s / ( 2 π {f}_{1} )}{( \frac{s}{2 π {f}_{1}} - 1 ) ( \frac{s}{2 π {f}_{2}} - 1 )}$$

where f₁ indicates the first cut-off frequency and f₂ the second.

Preferably, the derivative filter has a double pole in the range of 10 Hz-100 Hz. The transfer function F(S)_{der} of the filter is for example

$${F ( s )}_{der} = \frac{{s ( 2 π f )}^{2}}{{( s + 2 π f )}^{2}} ,$$

where f denotes the frequency of the deriving pole.

The method according to the invention may also include a further step f:
f. obtaining a signal representative of a velocity żᵢ of said angle i by filtering said acceleration \ddot{z}ᵢ with an integrating filter having a coincident double pole within a range of 0.1 Hz-5 Hz.
   Advantageously, step d., mentioned above, can be replaced by a step d*. in which said fifth signal \ddot{z}ᵢ^{diff} is calculated disregarding the dependence of said fifth signal \ddot{z}ᵢ^{diff} from said coordinate zᵢ of said relative position of said angle i, i.e.

$${\ddot{z}}_{i}^{diff} = - {x}_{i} {\dot{ω}}_{y} + {y}_{i} {\dot{ω}}_{x} + {y}_{i} {ω}_{y} {ω}_{z} + {x}_{i} {ω}_{x} {ω}_{z} ;$$

For this purpose, to minimise the measurement error between estimated corner accelerations and actual accelerations, it can be particularly advantageous to position the IMU preferably in the range of −0.5 m, +0.5 m, relative to the vehicle corners.

Also forming part of the same inventive concept is a method for obtaining a signal indicative of an acceleration \ddot{x}ᵢ of said at least one corner i of said vehicle, wherein said acceleration \ddot{x}ᵢ is directed along an axis parallel to said longitudinal axis (X) passing through said relative position [xᵢ, yᵢ, zᵢ]^{T} of said at least one corner i.

In performing this method, the vehicle IMU is configured to provide, in addition to at least said second, third and fourth signals, a sixth signal aₓ representative of an acceleration of said IMU along said longitudinal axis (X).
The method for obtaining a signal indicative of an acceleration \ddot{x}ᵢ of said at least one corner i of said vehicle comprises, in addition to at least steps b. and c. already mentioned, the following additional steps:
g. filtering said sixth signal aₓ with a band-pass filter to obtain a filtered sixth signal

$${a}_{x}^{bp} ;$$

h. calculating, for each corner i, a seventh signal \ddot{x}ᵢ^{diff} representative of the relative motion of corner i with respect to the IMU, where said fifth signal \ddot{x}ᵢ^{diff} is calculated from the kinematic equations of the rigid body, i.e.

$${\ddot{x}}_{i}^{diff} = [ \begin{matrix}- {ω}_{z}^{2} - {ω}_{y}^{2} & - {\dot{ω}}_{z} + {ω}_{x} {ω}_{y} & {\dot{ω}}_{y} + {ω}_{x} {ω}_{z}\end{matrix} ] \times {[ {x}_{i} , {y}_{i} , {z}_{i} ]}^{T} = - {y}_{i} {\dot{ω}}_{z} + {z}_{i} {ω}_{y} - {x}_{i} {ω}_{z}^{2} + {z}_{i} {ω}_{x} {ω}_{z} - {x}_{i} {ω}_{y}^{2} + {y}_{i} {ω}_{x} {ω}_{y} ; e$$

i. calculating, for each corner i, said acceleration \ddot{x}ᵢ of said at least one corner i as the sum of said sixth filtered signal

$${a}_{x}^{bp}$$

and said seventh signal \ddot{x}ᵢ^{diff} i.e. as \ddot{x}ᵢ=aₓ+\ddot{x}ᵢ^{diff};
   This method can be used advantageously in longitudinal dynamics control applications such as ABS and traction control.
   Similarly, the method of obtaining a signal indicative of an acceleration ÿᵢ of said at least one corner i of said vehicle is also part of the same inventive concept, wherein said acceleration ÿᵢ is directed along an axis parallel to said transverse axis (Y) passing through said relative position [xᵢ, yᵢ, zᵢ]^{T} of said at least one corner i.
   In performing this method, the vehicle IMU is configured to provide, in addition to at least said second, third and fourth signals, an eighth signal a_{y} representative of an acceleration of said IMU along said transverse axis (Y).
   The method for obtaining a signal indicative of an acceleration y of said at least one corner i of said vehicle comprises, in addition to at least steps b. and c. already mentioned, the following additional steps:
j. filtering said eighth signal a_{y} with a band-pass filter to obtain a filtered eighth signal

$${a}_{y}^{bp} ;$$

k. calculating, for each corner i, a ninth signal ÿᵢ^{diff} representative of the relative motion of corner i with respect to the IMU, where said fifth signal \ddot{x}ᵢ^{diff} is calculated from the kinematic equations of the rigid body, i.e.

$${\ddot{y}}_{i}^{diff} = [ \begin{matrix}{\dot{ω}}_{z} + {ω}_{x} {ω}_{y} & - {ω}_{z}^{2} - {ω}_{x}^{2} & - {\dot{ω}}_{x} + {ω}_{y} {ω}_{z}\end{matrix} ] \times {[ {x}_{i} , {y}_{i} , {z}_{i} ]}^{T} = {x}_{i} {\dot{ω}}_{z} - {z}_{i} {\dot{ω}}_{x} - {y}_{i} {ω}_{z}^{2} + {z}_{i} {ω}_{y} {ω}_{z} - {y}_{i} {ω}_{x}^{2} + {x}_{i} {ω}_{x} {ω}_{y} ; e$$

l. calculating, for each corner i, said acceleration ÿᵢ of said at least one corner i as the sum of said eighth filtered signal

$${a}_{y}^{bp}$$

and said ninth signal ÿᵢ^{diff} and that is as ÿᵢ=a_{y}+ŷᵢ^{diff}.
   This method can be used advantageously in lateral dynamics control applications such as stability control and sideslip angle estimation.
   It is to be understood that the method according to the invention as detailed above can for example be performed by a controller present in the vehicle and configured to receive the measurements produced by the IMU.
   The present invention has been described herein with reference to preferred examples of its implementation. It is to be understood that other embodiments or methods of implementation may be contemplated that share the same inventive core with those described herein, as defined by the scope of protection of the claims below.

1. A method for obtaining at least one signal indicative of an acceleration \ddot{z}₁₀f at least one corner i of a vehicle,
wherein said vehicle comprises an IMU configured to provide at least four signals, a first signal a_{z} representative of an acceleration of said IMU along a vertical axis passing through said IMU, a second signal ωₓ representative of an angular velocity of said IMU around a longitudinal axis passing through said IMU and perpendicular to said vertical axis, a third signal ω_{y} representative of an angular velocity of said IMU around a transverse axis passing through said IMU and perpendicular to said vertical axis and to said longitudinal axis, and a fourth signal oz representative of an angular velocity of said IMU about said vertical axis;
wherein said at least one corner i has a relative position [xᵢ, yᵢ, zᵢ]^{T} with respect to said IMU defined as a function of said longitudinal axis, transverse axis and vertical axis and is connected, substantially in a rigid way, to said IMU;
wherein said acceleration \ddot{z}ᵢ is directed along an axis parallel to said vertical axis passing through said relative position [xᵢ, yᵢ, zᵢ]^{T} of said at least one corner i;
said method comprising the steps of:
a. filtering said first signal a_{z} with a band pass filter to obtain a first filtered signal
$${a}_{z}^{bp} ;$$
b. filtering said second signal ωx with a derivative filter to obtain the angular acceleration \dot{ω}ₓ around the longitudinal axis;
c. filtering said third signal ω_{y} with said derivative filter to obtain angular acceleration \dot{ω}_{y} around the transverse axis;
d. calculating, for each corner i, a fifth signal \ddot{z}ᵢ^{diff} representative of the relative motion of the corner i with respect to the IMU, wherein said fifth signal \ddot{z}ᵢ^{diff} is calculated, by means of the kinematic equations of the rigid body, namely as
$${\ddot{z}}_{i}^{diff} = [ \begin{matrix}- {\dot{ω}}_{y} + {ω}_{x} {ω}_{z} & {\dot{ω}}_{x} + {ω}_{y} {ω}_{z} & - {ω}_{y}^{2} - {ω}_{x}^{2}\end{matrix} ] \times {[ {x}_{i} , {y}_{i} , {z}_{i} ]}^{T} = - {x}_{i} {\dot{ω}}_{y} + {y}_{i} {\dot{ω}}_{x} - {z}_{i} {ω}_{y}^{2} + {y}_{i} {ω}_{y} {ω}_{z} - {z}_{i} {ω}_{x}^{2} + {x}_{i} {ω}_{x} {ω}_{z} ; And$$
e. calculating, for each corner i, said acceleration \ddot{z}ᵢ of said at least one corner i as the sum between said first filtered signal
$${a}_{z}^{bp}$$
and said fifth signal \ddot{z}ᵢ^{diff}, i.e. \ddot{z}ᵢ=a_{z}+\ddot{z}ᵢ^{diff}.

2. The method according to claim 1, wherein said band pass filter has a first cutoff frequency in a range comprised between 0.1 Hz-2 Hz, and a second cut-off frequency in a range between 40 Hz-100 Hz.

3. The method according to claim 1, wherein said derivative filter has a pole in a range comprised between 10 Hz-100 Hz.

4. The method according to claim 1, wherein said method comprises the following further step subsequent to step e.:
f. obtaining a signal representative of a speed żᵢ of said corner i by filtering said acceleration \ddot{z}ᵢ with an integrating filter having a coincident double pole comprised in a 0.1 Hz-5 Hz range.

5. The method according to claim 1, wherein step d. is replaced by a step d*, in which said fifth signal \ddot{z}ᵢ^{diff} is calculated neglecting the dependence of said fifth signal \ddot{z}ᵢ^{diff} on said coordinate zᵢ of said relative position of said corner i, i.e.
$${\ddot{z}}_{i}^{diff} = - {x}_{i} {\dot{ω}}_{y} + {y}_{i} {\dot{ω}}_{x} + {y}_{i} {ω}_{y} {ω}_{z} + {x}_{i} {ω}_{x} {ω}_{z} ;$$

6. The method according to claim 1, wherein said method is further adapted to obtain a signal indicative of an acceleration \ddot{x}ᵢ of said at least one corner i of said vehicle, wherein said acceleration \ddot{x}ᵢ is directed along an axis parallel to said longitudinal axis and passing through said relative position [xᵢ, yᵢ, zᵢ]^{T} of said at least one corner i;
wherein said IMU of said vehicle is configured to provide a sixth signal aₓ representative of an acceleration of said IMU along said longitudinal axis,
said method comprising the additional steps of:
g. filtering said sixth signal aₓ with a band pass filter to obtain a filtered sixth signal
$${a}_{x}^{bp} ;$$
h. calculating, for each corner i, a seventh signal \ddot{x}ᵢ^{diff} representative of the relative motion of corner i with respect to the IMU, wherein said fifth signal \ddot{x}ᵢ^{diff} is calculated, by means of the kinematic equations of the rigid body, namely
$${\ddot{x}}_{i}^{diff} = [ \begin{matrix}- {ω}_{z}^{2} - {ω}_{y}^{2} & - {\dot{ω}}_{z} + {ω}_{x} {ω}_{y} & {\dot{ω}}_{y} + {ω}_{x} {ω}_{z}\end{matrix} ] \times {[ {x}_{i} , {y}_{i} , {z}_{i} ]}^{T} = - {y}_{i} {\dot{ω}}_{z} + {z}_{i} {ω}_{y} - {x}_{i} {ω}_{z}^{2} + {z}_{i} {ω}_{x} {ω}_{z} - {x}_{i} {ω}_{y}^{2} + {y}_{i} {ω}_{x} {ω}_{y} ; and$$
i. calculating, for each corner i, said acceleration \ddot{x}ᵢ of said at least one corner i as the sum between said sixth filtered signal
$${a}_{x}^{bp}$$
and said seventh signal \ddot{x}ᵢ^{diff} i.e. \ddot{x}ᵢ=aₓ+\ddot{x}ᵢ^{diff}.

7. The method according to claim 1, wherein said method is further adapted to obtain a signal indicative of an acceleration ÿᵢ of said at least one corner i of said vehicle, wherein said acceleration ÿᵢ is directed along an axis parallel to said transverse axis and passing through said relative position [xᵢ, yᵢ, zᵢ]^{T} of said at least one corner i;
wherein said IMU of said vehicle is configured to provide an eighth signal a_{y} representative of an acceleration of said IMU along said transverse axis,
said method comprising the additional steps of:
j. filtering said eighth signal a_{y} with a band pass filter to obtain a filtered eighth signal
$${a}_{y}^{bp} ;$$
k. calculating, for each corner i, a ninth signal ÿᵢ^{diff} representative of the relative motion of the corner i with respect to the IMU, wherein said fifth signal \ddot{x}ᵢ^{diff} is calculated, by means of the kinematic equations of the rigid body, namely
$${\ddot{y}}_{i}^{diff} = [ \begin{matrix}{\dot{ω}}_{z} + {ω}_{x} {ω}_{y} & - {ω}_{z}^{2} - {ω}_{x}^{2} & - {\dot{ω}}_{x} + {ω}_{y} {ω}_{z}\end{matrix} ] \times {[ {x}_{i} , {y}_{i} , {z}_{i} ]}^{T} = {x}_{i} {\dot{ω}}_{z} - {z}_{i} {\dot{ω}}_{x} - {y}_{i} {ω}_{z}^{2} + {z}_{i} {ω}_{y} {ω}_{z} - {y}_{i} {ω}_{x}^{2} + {x}_{i} {ω}_{x} {ω}_{y} ; and$$
l. calculating, for each corner i, said acceleration ÿᵢ of said at least one corner i as the sum between said eighth filtered signal
$${a}_{y}^{bp}$$
and said ninth signal ÿᵢ^{diff} that is ÿᵢ=a_{y}+ÿᵢ^{diff}.

8. The method according to claim 1, wherein said vehicle is a four-wheeled vehicle, each wheel being equipped with a suspension, and said at least one corner i comprises four corners, each in correspondence with a respective suspension, a front left corner, a front right front, right rear corner, left rear corner.

9. A vehicle comprising at least one suspension at a respective at least one corner of said vehicle,
wherein said vehicle comprises an IMU configured to provide at least four signals, a first signal a_{z} representative of an acceleration of said IMU along a vertical axis passing through said IMU, a second signal representative ωₓ of an angular velocity of said IMU around a longitudinal axis passing through said IMU, a third signal ω_{y} representative of an angular velocity of said IMU about a transverse axis passing through said IMU, and a fourth signal ω_{z} representative of an angular velocity of said IMU about said vertical axis,
wherein said at least one corner i has a relative position [xᵢ, yᵢ, zᵢ]^{T} with respect to said IMU defined as a function of said longitudinal axis, transverse axis and vertical axis and is connected, substantially in a rigid way, to said IMU;
wherein said acceleration \ddot{z}ᵢ is directed along an axis parallel to said vertical axis passing through said relative position [xᵢ, yᵢ, zᵢ]^{T} of said at least one corner i;
wherein said vehicle comprises a controller configured to perform the method steps according to claim 1.
